(19) United States
(12) Patent Application Publication
(10) Pub. No.: US 2019/0136446 A1
(43) Pub. Date: May 9, 2019

(54) TEXTURED REFLECTIVE SYNTHETIC LEATHER

(71) Applicant: Safe Reflections, Inc., St. Paul, MN (US)

(72) Inventor: Aaron K. Brannan, Minneapolis, MN (US)

(21) Appl. No.: 16/309,852

(22) PCT Filed: Jun. 23, 2017
(86) PCT No.: PCT/US2017/038936

§ 371 Date: Dec. 13, 2018

Related U.S. Application Data
(60) Provisional application No. 62/355,617, filed on Jun. 28, 2016.

(51) Int. Cl. D06N 3/14; B32B 17/10; B32B 27/40; B32B 7/12

(52) U.S. Cl. CPC D06N 3/14; B32B 17/1077; B32B 27/40; B32B 2309/105; B32B 2437/00; B32B 2307/416; B32B 7/12

(57) ABSTRACT

A retroreflective article in which the retroreflective optical elements are arranged to create a textured surface which improves abrasion performance and reflectivity at certain entrance and observation angles.

### CROSS-REFERENCE TO RELATED APPLICATION

This application claims the benefit of U.S. Provisional application No. 62/355,617, filed Jun. 28, 2016, the contents of which are incorporated by reference in its entirety.

### BACKGROUND OF THE INVENTION

Retroreflective materials of various kinds have been use for many years to improve the nighttime visibility of pedestrians, traffic control devices, and numerous other objects. Retroreflective materials are designed to reflect light in the primary direction of the incident light in this manner, incident light such as that of automobile headlights is reflected back to the automobile, making the presence of the wearer clearly visible to the driver of the vehicle. The same easy visualization can be obtained using spotlights, searchlights and even flashlights.

Prior retroreflective technology for textiles and garments includes an array of transparent retroreflective elements partially embedded with a reflective undercoating in a binder layer which, in turn, binds the embedded beads to a layer of material which can be fixed to an article of clothing. The retroreflective elements are generally spherical glass microbeads. The technology has been generally based on one of several techniques.

One technique involves heat transfer films in which glass beads are hemispherically vapor-coated with a reflective material (silver, aluminum or a clear mirror coat used on white/clear reflective films). These beads are then deposited on a bead-bonding adhesive such that the reflective-coated side is in contact with the bead-bonding adhesive and the non-coated side is exposed. The bead bond adhesive is then coated with a second adhesive which provides adhesion to a garment. This adhesive is commonly a hot-melt adhesive designed for heat lamination to a fabric.

Another approach involves retroreflective fabrics. These fabrics are quite similar in construction to heat transfer films, however, in this case a fabric layer is applied and bonded to the second adhesive directly after coating and before application to a garment. This produces a reflective fabric construction that can be stored and later sewn onto garments.

In the cases of films and fabrics, generally the retroreflective material has a flat surface appearance once applied, and the glass beads are oriented in the same direction. Due to the nature of the retroreflective material, there is a fairly narrow range of angles in which it reflects light.

Depending on the bonding adhesive used, the reflective beads can be bonded to virtually any material. There are several patents on using a synthetic leather as the backing fabric for retroreflective materials (CN 103374834 A, CN202626717U, U.S. Pat. No. 5,900,978A, CN204687501U). However, there has been no exploration of the effect of texturing the retroreflective material to improve the angularity of retroreflection or abrasion performance.

National and International safety standards for High Visibility Safety Garments, such as ANSI/ISEA 107 and ISO 20471 require that reflective materials have a set of required reflectivity measurements at multiple entrance (the angle between the light source and the reflective material surface) and observation angles (the angle between the retroreflective article, and the observer). Generally, as the entrance and observation angles are increased, there is a reduction in reflectivity measurements. Higher reflectivity at higher entrance and observation angles is commonly referred to as having improved angularity.

Colorized retroreflective material, with a colorizing coating on the surface, generally has poor angularity due to the nature of the surface coating, and how the surface coating reflects, refracts, and diffuses light. For this reason, it has not been possible to create a colored reflective material that is compliant with the prevailing international standards for occupational high visibility apparel.

Under abrasion, the glass beads are typically damaged or removed more along high points in the surface. In flat reflective materials, the entire surface is generally damaged during abrasion, limiting the reflective performance to the strength of the bond between the glass beads and the binder.

Additionally, due to the location of the colorizing layer being on the surface, the color is susceptible to being damaged first due to abrasion. For this reason, it is desirable to provide methods for improving abrasion performance and angularity performance.

### BRIEF SUMMARY OF THE INVENTION

The present invention relates generally to retroreflective materials with surface texture to improve retroreflective brightness at certain angles and to improve abrasion performance.

The present invention overcomes the previous limitations of reflective material, colorized or otherwise and improves angularity and reflective performance through a reflective layer that closely or exactly replicates and/or substantially maintains the texture of an underlying support/substrate, making them more suitable for applications such as footwear, belts, car interior upholstery, apparel (jackets, vests, glove, hats, etc.), and other applications that would require abrasion resistance, and where improved visual angularity would be preferential.

The reflective material of the present invention provide abrasion resistance and possess flexibility making them more suitable for applications such as footwear, car interior upholstery, and other applications that would require abrasion resistance, and where improved angularity would be preferential.

According to one aspect of the present invention, a reflective material with a suitable adhesive is applied to a textured substrate such that the reflective material attains the texture of the substrate. In order to achieve this, the reflective material must be sufficiently thin to conform to and replicate the underlying texture as to not negate the effect of the underlying textured substrate. Additionally, the bonding process must not damage or alter the texture of the underlying textured substrate.

Another aspect of the invention is thus the selection of the process and type of substrate that would be suitable for a given reflective material. If a heat-bonding process is used, the substrate must be heat stable in the temperature range with which the bonding process occurs. The depth of the textured surface is also important, that is if it is not sufficiently deep, the texture of the reflective article will not be sufficient to provide improved angularity.

### BRIEF DESCRIPTION OF THE DRAWINGS

FIG. 1 depicts the textured retroreflective film or fabric in accordance with the invention.

### DETAILED DESCRIPTION OF THE INVENTION

The following detailed description presents certain embodiments to illustrate the inventive concepts, but which are meant by way of example only and are not intended to limit the scope of the invention in any manner. The inventive reflective material and process of applying to a textured support or substrate can be effectively given a textured or relief appearance and feel through the application of these material e.g., films, to a textured support/substrate.

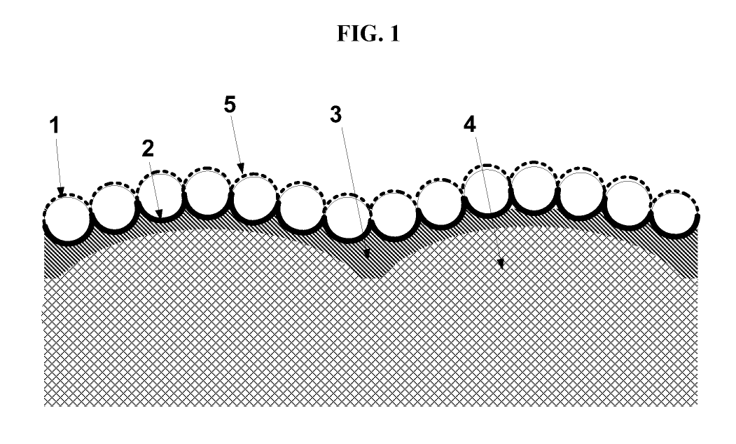

As illustrated in FIG. 1, a textured material 4, formed from a synthetic material or natural material, includes a ribbed pattern, and an array of glass bead reflective elements 1 partially embedded in an adhesive binder layer 3, with an external vapor-deposited or chemically coated reflective material at 2. The reflective layer may also be a pigmented adhesive in the case that the reflective coating 2 is non-metallic or otherwise translucent. In this way, the color of the reflective material would be determined by the color of the adhesive. The adhesive is then affixed to a textured material 4. Optionally, a colorizing coating 5 may be coated on the exterior of the retroreflective elements.

Although FIG. 1 illustrates a ribbed pattern, the textured material could have other surface designs, such as, but not limited to grains, dimples, undulations, embossments, concentric quarter arcs, semi-circular arcs, arcuate, concentric geometric objects, e.g., circles, squares, rectangles, etc., random texturing, woven textures, fabric texture, etc.

Textured materials that are suitable for the present invention are most suitable if they are thermoset materials which are soft, but sufficiently cross-linked such that they do not deform under the heat of the application process. Examples include epoxys, cross-linked polyurethanes, cross-linked polyesters, cross-linked polyester-polyamids, rubber, polyvinyl chloride, acrylic-based polymers, etc. For example, a fabric, woven or non-woven (a fabric or mat of a natural or synthetic fibrous material, such as nylon, Orlon, Dacron, rayon, cotton, felts of animal hair, wool and the like impregnated with a cross-linked polyurethane resin. Alternatively, it has been found that thermoplastic materials can be sufficient given that their texture can be preserved through the application process. This is the case if the application temperature for applying the reflective material is far below the temperature at which the substrate deforms, softens, or melts.

A further aspect of this invention is the shape of the texture that is being imparted on the reflective material will heavily affect the performance of the textured reflective material. Sufficient texture depth, and the shape of the texture profile provide for the curvature of the reflective surface such that improve angularity is imparted as a function of the texture.

### EXAMPLES

The invention will be further described by the following examples which are intended to illustrate the invention and not to limit the scope of the concepts in any manner.

Unless otherwise indicated the following test methods were used:

Retroreflectivity: Retroreflective brightness was measured using a retroreflectometer (RoadVista Model 932C) at the various entrance and observation angles listed.

Color: the daytime color of the colorized reflective materials were measured using a colorimetric spectrophotometer with 45°/0° optics, a density status setting of T, a standard illuminant D65 light source setting, and a standard observer setting of 2°.

### Example 1

Four samples of Brilliant® Colorized Reflective (a product of Safe Reflection) were prepared through colorization of 3M™ Scotchlite™ C725 retroreflective film, one ‘bronze’ on color, one ‘green’ in color, one ‘dark blue’ in color, and one ‘black’ in color using the method described in U.S. Pat. No. 8,470,394 B2.

A sheet of each color reflective material was cut into two identical pieces. One set of samples were laminated first to a flat, untextured fabric using a Hix 840 D clamshell-style heat press using a lamination temperature of 275-350 F, pressure setting between 10 and 60 psi, and dwell times between 10 and 20 seconds. What adhesives and characteristics are required? (the adhesive used in this case was a polyurethane-based hotmelt adhesive. The required adhesive depends on the surface treatment of the synthetic leather) A second set of the reflective materials were laminated onto a sample of textured synthetic leather (Majilite Corporation). The surface texture was dimpled, such as the embossed pattern on the surface of football leather.

After lamination, a sample was cross-sectioned with a razor blade, and a series of cross-sectional images were obtained under magnification. Overall thickness measurements were obtained using a micrometer, and these measurements were used as a basis for determining the relative dimensions of the textured reflective material. The overall thickness of the material was measured to be 0.032″. Using the magnified images, the depth of each dimple was determined to be approximately 0.004″ by measuring the difference between the thickest area and subtracting the thickness of the thinnest area. The lowest area between each dimple was determined to be approximately 0.002″ wide. After lamination, the retroreflectivity of each material was tested at each of the entrance/observation angle pairs listed in the ANSI/ISEA 107 and ISO 20471 standards. The results are detailed in Table 1 below. As the entrance and observation angles were increased, the reflectivity of the textured sample improved in comparison to the flat samples. Due to the texturing effect, some of the glass beads along the edges of the raised bumps in the material are aligned at different angles and are such situated to improve reflectivity at wider angles.

Analysis of the data shows that due to the reflective material attaining the texture of the synthetic leather, the reflectivity profile change significantly. The low-entrance and low-observation angle measurement decreased slightly due to the misalignment effect of the texturing. The reduction in the flatness of the reflective surface causes reduced reflectivity at lower entrance and observation angles. The loss in reflectivity at lower entrance angles and observation angle of 5 is substantial, but less significant than the large increases in reflectivity at higher entrance and observation angles where the reflectivity of reflective materials is generally lower due to the nature of the materials.

The increase in reflectivity at high entrance and observation angles varies widely among the different samples tested, but significant increases were found in a few specific sets of measurement angles. This effect is substantial in data obtained with observation angles of 0.2, and entrance angle of 40, where the increase varies between 20% and 50% increased reflectivity between the flat and textured samples. A substantial improvement is also observed in the data obtained with an observation angle of 0.33 and entrance angles of 30 and 40, where the increase varies between 2% and 91%. As the observation angle increases to 1 and 1.5, the overall retroreflectivity is reduced, and more modest increases are observed at entrance angles of 30 and 40.

The improvement in the reflectivity at wider angles as a result of creating texture results in improved visibility of the reflective material to a driver at night when the reflective material surface is situated such that it is not facing the headlights directly, and when the wearer of the reflective material is further away from the roadway (entrance angle).

TABLE 1
Retroreflectivity of flat and textured colorized retroreflective material.

| | | | Reflectivity (cd/lux-m2) | | | | | | | |
|---|---|---|---|---|---|---|---|---|---|---|
| Obs. | Ent. | | | | | | Dark | Dark | | |
| Angle | Angle | Min- | Bronze/ | Bronze/ | Green/ | Green/ | Blue/ | Blue/ | Black/ | Black/ |
| (deg) | (deg) | imum | Flat | Textured | Flat | Textured | Flat | Textured | Flat | Textured |
| 0.2 | 5 | 330 | 390 | 271 | 383 | 321 | 345 | 302 | 332 | 265 |
| | 20 | 290 | 116 | 126 | 136 | 140 | 107 | 107 | 115 | 105 |
| | 30 | 180 | 35.9 | 42.89 | 42.6 | 55.7 | 31.6 | 35.2 | 36.8 | 36.5 |
| | 40 | 65 | 8.85 | 14.9 | 10.3 | 16.9 | 6.9 | 8.3 | 5.79 | 8.73 |
| 0.33 | 5 | 250 | 231 | 195 | 250 | 229 | 230 | 203 | 228 | 175 |
| | 20 | 200 | 101 | 99 | 108 | 114 | 83.9 | 90.4 | 98.1 | 87.2 |
| | 30 | 170 | 30.2 | 40.7 | 41.8 | 51.9 | 30.8 | 31.8 | 32.2 | 33.4 |
| | 40 | 60 | 9.42 | 15.1 | 7.9 | 15.1 | 6.82 | 7.91 | 4.59 | 8.04 |
| 1 | 5 | 25 | 69.6 | 65.5 | 59.5 | 58.5 | 53.7 | 108 | 43.1 | 39 |
| | 20 | 15 | 50 | 47.5 | 40.4 | 43.2 | 38.1 | 68 | 34.2 | 28.8 |
| | 30 | 12 | 27.3 | 28.6 | 27.4 | 26.7 | 19.2 | 25.3 | 21.7 | 19.2 |
| | 40 | 10 | 11.3 | 14.2 | 10.2 | 13.5 | 8.7 | 6.54 | 7.79 | 8.77 |
| 1.5 | 5 | 10 | 35.6 | 34.8 | 29.6 | 29.9 | 24.9 | 25.9 | 19.6 | 19.9 |
| | 20 | 7 | 33.3 | 31.2 | 27.1 | 26.6 | 21.8 | 21.8 | 15.9 | 16.3 |
| | 30 | 5 | 20.5 | 20.9 | 16 | 18.2 | 13.2 | 13.8 | 11.5 | 10.3 |
| | 40 | 4 | 10.5 | 11.7 | 9.28 | 10.5 | 7.28 | 7.2 | 6.16 | 6.5 |

1. A retroreflective material comprising
i. A retroreflective layer of reflective elements attached to a binder layer
ii. A textured surface such that the layer of reflective elements are oriented in multiple directions

2. A retroreflective material as in claim 1 which has a colorizing composition applied to the surface

3. A retroreflective material as in claim 1 which contains an aluminum vapor coat

4. A reflective material as in claim 1 which does not contain an aluminum vapor coat reflective material as in claim 4 which has a pigmented or colored binder layer

6. A reflective material as in claim 1 which the texture is provided through embossing

7. A reflective material as in claim 1 which comprises a thermoplastic polyurethane

8. A reflective material as in claim 1 which comprises a synthetic leather

9. A reflective material as in claim 1 which comprises a woven fabric backing

10. A reflective material as in claim 1 which comprises a non-woven fabric backing

11. A reflective material as in claim 1 which comprises an abrasion resistant coating on the surface of the reflective elements.

12. A reflective material as in claim 1 which comprises a thermoset polyurethane

13. A reflective material as in claim 1 which comprises a textured substrate with thicknesses between 0.001″ and 0.25″.

14. A reflective material as in claim 1 which comprises a textured substrate with a difference of 0.0002 and 0.10 inch between the thinnest and thickest points.

15. A reflective material as in claim 1 including a printed pattern on the reflective

16. A reflective material as in claim 1 which has a transparent bonding adhesive between the glass beads and the textured substrate.

17. A method of preparing the reflective material of claim 1, comprising heat lamination of the reflective material having an adhesive backing to a suitable substrate.

18. A method of preparing the reflective material of claim 1, comprising the use of a liquid adhesive to adhere the reflective material to a suitable substrate.

19. A method of preparing the reflective material of claim 1, comprising pressure sensitive adhesion of the reflective material having an adhesive backing to a suitable substrate.
